(19) United States
(12) Patent Application Publication
(10) Pub. No.: US 2010/0005522 A1
(43) Pub. Date: Jan. 7, 2010

(54) Digital transmission system (DTS) for computer security

(76) Inventor: Behruz Nader Daroga, Brampton (CA)

Correspondence Address: FAY SHARPE LLP, 1228 Euclid Avenue, 5th Floor, The Halle Building, Cleveland, OH, 44115, US

(21) Appl. No.: 12/439,634

(22) PCT Filed: Aug. 29, 2006
(86) PCT No.: PCT/CA06/01548

§ 371 Date: Mar. 2, 2009

(51) Int. Cl. G06F 7/04; G06F 21/00

(52) U.S. Cl. 726/17

(57) ABSTRACT

This invention describes a hand held digital transmitter to transmit a signal as light (visible and invisible) or sound (audible and inaudible) or other digitized code for alphanumeric in any language, special characters or symbols or graphic or pictures or any combination thereof, to the computer system that is equipped with a compatible digital receiver and transmitter card. This card can transmit and receive the said signals and codes and a software driver and/or firmware for the operation, management and maintenance of this security system. Upon verification, of the transmitted code, by the computer system, access is granted. The computer system then transmits a randomly selected new code of any combination of the codes or signals stated above to the transmitter for storage in the said transmitter. The said transmission from the computer cannot be stored in any other hand held transmitter located within range of the transmission.

This application claims the priority benefit of International Application Number PCT/CA2006/001548, filed Aug. 29, 2006 the disclosure of which is incorporated herein by reference.

### FIELD OF INVENTION

This invention relates to a computer security system utilizing a digital transmission that is changed after each use of the system.

### BACKGROUND

Conventional security systems for computers utilize one of several methods, i.e., by provision of a User ID and password, by voice recognition, or by using biometrics systems. Passwords need to be easily remembered but should not be able to be “guessed” and should not be written down. However, these restrictions also leave the system vulnerable to hacking by unauthorized users using software or spyware or phishing. Voice recognition systems require appreciable memory space, are slower to respond, and voices can be recorded accurately and played back to the computer security system leaving the system vulnerable to hacking. Biometrics systems can encounter user resistance since the biometrics information can be misused if it falls into malevolent hands. Even security systems using 32 bit encryption, one of the most secure systems in use, have been hacked using software.

Clearly a need is identified for a “hacker proof” security system especially for use in systems deployed in Government, Department of Defense, Banks, large multinational corporations and anywhere where sensitive data and documents are stored.

### BRIEF DESCRIPTION

The drawbacks of the present practice for computer security are eliminated with the use of a hand held digital transmitter and a compatible ‘card’ inserted in the computer. Any existing computer system can be equipped to use the DTS for computer security with the use of a compatible card. The hand held transmitter used for computer security is capable of transmitting (and receiving and storing) a signal or code which can be light (visible and invisible) or sound (audible and inaudible) or other digitized code for alphanumeric in any language, special characters or symbols or graphic or pictures or any combination thereof. The source of sound can be computer generated or pre-recorded from a vast array of sources. These sources are listed in, but not limited to, the list in appendix 1. The list of pictures can be similarly taken from, but not limited to the said appendix. Variables for alphanumeric in any language, special characters, symbols, light, or graphics are equally vast. A code comprised of any one of these signals would present a daunting task to any hacker. When used in combination, the system would be impossible to hack.

### BRIEF DESCRIPTION OF THE DRAWINGS

FIG. 1 illustrates the use of the system. The computer system ‘A’ (standalone or networked) which is equipped with the said ‘card’ and transmitter ‘B’ are factory pre-set with a code (the default code). On set up of the system, the user can select from options to use the conventional system or the digitized transmission system for security. On first use of the system, the user is prompted to change the password of the conventional system. If the security system using digitized transmission was selected on set up, the conventional system would be inoperable.

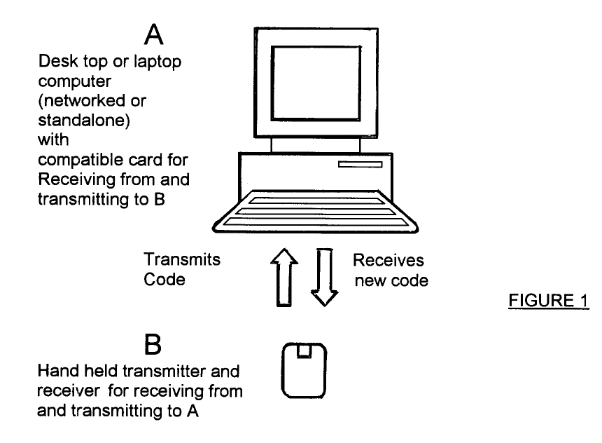

### DETAILED DESCRIPTION

On first use of the digitized transmission system, the default code is transmitted from B to A. This also identifies the specific transmitter ‘B’ to ‘A’. On verification by the system of the code, access to the computer system is granted and a new randomly selected code is transmitted from A to B. This new code is stored in A as well as B. The new code is randomly selected by the system and can be any one of the light (visible or invisible), sound (audible or inaudible) alphanumeric in any language, symbols, special characters, graphics or pictures. These variables are pre-recorded and saved on the computer. User defined variables can also be pre-recorded by the user. The more variables that are pre-recorded, the greater the protection afforded to the system. On logging off, and re-use of the system, the new code is transmitted by ‘B’ to ‘A’ and verified by the system which generates and transmits a new randomly selected code and grants access.

This process continues for each use of the system. Therefore passwords are changed on each use and do not need to be remembered. The codes would be impossible to hack. Recording the transmitted signal would serve no purpose as this signal is changed on each use. The response time to this system would be much quicker and require less memory space than conventional voice recognition systems. The new code transmitted by ‘A’ cannot be received and stored in any other hand held transmitter located within range of the signal, since the system will only respond to a specified transmitter. The system cannot be hacked remotely, from the keyboard or even by spyware or software unintentionally downloaded from e-mails and internet sites since the system will only respond to the specified transmitter. Needless to say, the transmitter has to be located in a secure place.

Certain applications require an electronic signature to be applied to records that are created, updated, edited, deleted, reviewed or approved. When prompted for a password for these changes, the same digital signal from ‘B’ can be used for the purposes of an electronic signature. Documents and data and records requiring ultimate security can be similarly protected by requiring a password to open said documents, data or records.

The codes transmitted and received are user specific enabling multiple users to operate the DTS system on the same network or on a standalone. In the event, the hand held transmitter is lost or stolen, the security system can be re-set to default by “booting up” from the operating system CD from the CD drive. However, if on boot up, the operating system detects a DTS card, the conventional security system will operate and the user will be required to enter the new password that was recorded on initial set up. On successful re-boot and on acquiring a new transmitter, the default code can be transmitted and the system used as before.

### APPENDIX 1

Sources and agents of sound and pictures include but not limited to:
1. Human beings and animals, birds, insects. fish, whales, dolphins.
2. In any language, music, songs, videos, themes music from films. Musical instruments and tuning forks.
3. Running water, rain water, waterfalls, tributaries, rivers lakes, melting snow and ice, piped water, treated and untreated water, icebergs, glaciers.
4. Volcanoes, hurricanes, tornadoes, gales, ordinary wind, solar wind, earthquakes, tsunami, lightning and thunder or any other sounds from nature.
5. Operating machines of any size, anywhere in any industry including ultrasound.
6. Transport vehicles of any size, powered or manual, used anywhere.
7. Objects falling to earth from sky.
8. Explosions, avalanches.
9. Elevators.
10. Sporting events and stadiums, race courses.
11. Church or religious services conducted anywhere in any religion.
12. Clock tower bells, church bells in any religion anywhere, door bells and chimes.
13. Public meetings and demonstrations.
14. Theme park, funfare and circus sounds.
15. Farms and markets.

What is claimed is:

1-4. (canceled)

5. A system for providing access authorization to a processor, comprising:
a security device for transmitting a current signal upon user command once only along a communications interface and for receiving a subsequent signal along the communications interface; and
security means associated with the processor for:
a. precluding user access to the processor until the security means receives a signal along the communications interface that matches the current signal; and
b. thereafter generating and transmitting along the communications interface the subsequent signal for authorizing a subsequent user access of the processor.

6. The system according to claim 5, wherein the security device comprises means for temporarily storing the current signal received along the communications interface until it is retransmitted back along the communications interface.

7. The system according to claim 5, wherein the security means comprises means for temporarily storing the current signal until it is successfully matched against the received signal along the communications interface.

8. The system according to claim 5, wherein the security device and the security means are preconfigured before use with a default signal as the current signal.

9. The system according to claim 5, wherein the communications interface is restricted to communications between the security device and the security means.

10. The system according to claim 5, wherein the signals passing along the communications interface are based on technology selected from a group consisting of: visible light, invisible light, audible sound, inaudible sound, digitized codes for alphanumeric characters in a language, digitized codes for special characters, digitized codes for symbols, digitized codes for graphics, digitized codes for pictures and a combination of one or more of the members of the group.

11. The system according to claim 5, wherein the signals passing along the communications interface are recorded from a source selected from a group consisting of: computer-generated material; human beings, animals, birds, insects, fish, whales, dolphins; music, songs, videos, theme music from films, musical instruments, tuning forks, running water, rain water, waterfalls, tributaries, rivers, lakes, melting snow, melting ice, piped water, treated water, untreated water, icebergs, glaciers, volcanoes, hurricanes, tornadoes, gales, ordinary wind, solar wind, earthquakes, tsunami, lightning, thunder, sounds from nature, operating machines of any size anywhere in any industry, ultrasound, transport vehicles of any size, powered or manual, used anywhere, objects falling to earth from sky, explosions, avalanches, elevators, sporting events, stadiums, race courses, church or religious services conducted anywhere in any religion, clock tower bells, church bells in any religion anywhere, door bells, chimes, public meetings, demonstrations, theme parks, funfare, circus sounds, farms and markets.

12. The system according to claim 5, wherein the current signal and/or the subsequent signal is randomly selected.

13. The system according to claim 5, wherein the current signal and/or the subsequent signal is chosen from a library of pre-recorded signals accessible by the security means.

14. The system according to claim 13, wherein the library of pre-recorded signals comprise signals pre-recorded by a user.

15. The system according to claim 5, wherein the security means comprises a card installed within a computer housing the processor.

16. The system according to claim 5, wherein the current signal and/or the subsequent signal is digitized.

17. The system according to claim 5, wherein the current signal is used as an electronic signature associated with a user of the security device.

18. The system according to claim 5, wherein the security device is a handheld device.

19. A method of providing access authorization to a processor, comprising the acts of:
a. providing to a user a security device;
b. restricting access to the processor by the user until a security means associated with the processor receives a signal along a communications interface that matches the current signal;
c. upon user input at the security device, transmitting once only the current signal along the communications interface;
d. thereafter generating at the security means a subsequent signal for authorizing a subsequent user access of the processor; and
e. the security means transmitting the subsequent signal to the security device along the communications interface.

20. A security device for providing access authorization to a processor, adapted to transmit, upon user command, a current signal once only along a communications interface and thereafter to receive a subsequent signal along the communications interface, and;
whereby security means associated with the processor may:
a. preclude user access to the processor until the security means receives a signal along the communications interface that matches the current signal; and
b. thereafter generate and transmit along the communications interface the subsequent signal for authorizing a subsequent user access of the processor.

21. A security means associated with a processor for:
a. precluding user access to the processor until the security means receives a current signal along a communications interface that matches a current signal; and
b. thereafter generating and transmitting along the communications interface a subsequent signal for authorizing a subsequent user access of the processor;
whereby a security device configured to transmit, upon user command, the current signal once only along the communications interface and thereafter to receive the subsequent signal along the communications interface may provide access authorization to the processor.
